(19) United States
(12) Patent Application Publication
(10) Pub. No.: US 2007/0186045 A1
(43) Pub. Date: Aug. 9, 2007

(54) Cache eviction technique for inclusive cache systems

(76) Inventors: Christopher J. Shannon, Hillsboro, OR (US); Mark Rowland, Beaverton, OR (US); Ganapati Srinivasa, Portland, OR (US)

Correspondence Address: BLAKELY SOKOLOFF TAYLOR & ZAFMAN, 1279 OAKMEAD PARKWAY, SUNNYVALE, CA, 94085-4040, US

(21) Appl. No.: 10/897,474

(22) Filed: Jul. 23, 2004

(51) Int. Cl. G06F 12/00

(52) U.S. Cl. 711/133

(57) ABSTRACT

A technique for intelligently evicting cache lines within an inclusive cache architecture. More particularly, embodiments of the invention relate to a technique to evict cache lines within an inclusive cache hierarchy based on the potential impact to other cache levels within the cache hierarchy.

### FIELD

Embodiments of the invention relate to microprocessors and microprocessor systems. More particularly, embodiments of the invention relate to caching techniques of inclusive cache hierarchies within microprocessors and computer systems.

### BACKGROUND

Prior art cache line replacement algorithms typically do not take into account the effect of an eviction of a cache line in one level of cache upon a corresponding cache line in another level of cache in a cache hierarchy. In inclusive cache systems containing multiple levels of cache within a cohesive cache hierarchy, however, a cache line evicted in an upper level cache, for example, can cause the corresponding cache line within a lower level cache to become invalidated or evicted, thereby causing a processor or processors using the evicted lower level cache line to incur performance penalties.

Inclusive cache hierarchies typically involve those containing at least two levels of cache memory, wherein one of the cache memories (i.e. “lower level” cache memory) includes a subset of data contained in another cache memory (i.e. “upper level” cache memory). Inclusive cache hierarchies are useful in microprocessor and computer system architectures, as they allow a smaller cache having a relatively fast access speed to contain frequently used data and a larger cache having a relatively slower access speed than the smaller cache to store less-frequently used data. Inclusive cache hierarchies attempt to balance the competing constraints of performance, power, and die size by using smaller caches for more frequently used data and larger caches for less frequently used data.

Because inclusive cache hierarchies store at least some common data, evictions of cache lines in one level of cache may necessitate the corresponding eviction of the line in another level of cache in order to maintain cache coherency between the upper level and lower level caches. Furthermore, typical caching techniques use state data to indicate the accessibility and/or validity of cache lines. One such set of state data includes information to indicate whether the data in a particular cache line is modified (“M”), exclusively owned (“E”), able to be shared among various agents (“S”), and/or invalid (“I”) (“MESI” states).

Typical prior art cache line eviction algorithms and techniques do not consider the effect on state variables, such as MESI states, in other levels of cache to which an evicted cache line corresponds. FIG. 1, for example illustrates a typical prior art 2-level cache hierarchy, in which a lower level cache, such as a level-1 (“L1”) cache contains a subset of data stored in an upper level cache, such as a level-2 (“L2”) cache. Each line of the L1 cache of FIG. 1 typically contains MESI state data to indicate to requesting agents the availability/validity of data within a cache line. Cache data and MESI state information is maintained between the L1 and L2 caches via coherency information between the cache levels.

However, in typical prior art cache line eviction algorithms, the state of data within the L1 cache is not considered when deciding which line of the L2 cache to evict. Because an eviction in the L2 cache can cause an eviction of the corresponding data in the L1 cache, in order to maintain coherency, an eviction of a cache line in the L2 cache can cause the processor to incur performance penalties the next time the processor needs to access the evicted data from the L1 cache. Whether the processor will likely need the evicted L1 cache data typically depends upon the MESI state of the data.

For example, if a line being evicted in the L2 cache corresponds to a line in the L1 cache that has been modified, and therefore in the “M” state, the processor may have to resort to issuing a bus access to a main memory source to retrieve the data next time it needs the data. However, if the data in the L1 cache to which the evicted line corresponds in the L2 cache was marked as invalidated in the L1 cache (i.e. “I” state), for example, there may be no performance penalty, as the processor may need to update the data in the L1 cache anyway.

Accordingly, cache line eviction techniques that do not take into account the effect of a cache line eviction on lower level cache structures within the cache hierarchy can cause a processor or processors having access to the lower level cache to incur performance penalties.

### BRIEF DESCRIPTION OF THE DRAWINGS

Embodiments of the invention are illustrated by way of example and not limitation in the figures of the accompanying drawings, in which like references indicate similar elements and in which:

FIG. 1 is a prior art cache hierarchy in which cache eviction in an upper level cache is done irrespective of the state of the corresponding data in the lower level cache.

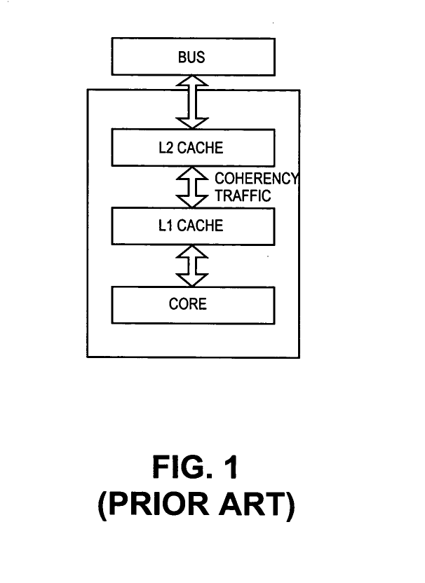

FIG. 2 is a front-side-bus (FSB) computer system in which one embodiment of the invention may be used.

FIG. 3 is a point-to-point (PtP) computer system in which one embodiment of the invention may be used.

FIG. 4 is a single core microprocessor in which one embodiment of the invention may be used.

FIG. 5 is a table illustrating performance penalties for each of a group of possible lower level cache evictions and victim properties corresponding to a single-core microprocessor according to one embodiment of the invention.

FIG. 6 is a table illustrating a cache line eviction algorithm based on the states of a line in an upper and lower level cache within a single core processor according to one embodiment of the invention.

FIG. 7 is a multi-core microprocessor in which one embodiment of the invention may be used.

FIG. 8 is a table illustrating performance penalties for each of a group of possible lower level cache evictions and victim properties corresponding to a multi-core microprocessor according to one embodiment of the invention.

FIG. 9 is a table illustrating a cache line eviction algorithm based on the states of a line in an upper and lower level cache within a multi-core processor according to one embodiment of the invention.

### DETAILED DESCRIPTION

Embodiments of the invention relate to caching architectures within computer systems. More particularly, embodiments of the invention relate to a technique to evict cache lines within an inclusive cache hierarchy based on the potential impact to other cache levels within the cache hierarchy.

Performance can be improved in computer systems and processors having an inclusive cache hierarchy, in at least some embodiments of the invention, by taking into consideration the effect of a cache line eviction within an upper level cache line on the corresponding cache line in a lower level cache or caches. Particularly, embodiments of the invention take into account whether a cache line to be evicted within an upper level cache corresponds to a line of cache in a lower level cache as well as the state of data within the corresponding lower level cache line.

For example, in one embodiment of the invention, cache lines contain information to indicate whether the cache line contains data that is modified (“M”), exclusively owned by an agent within the processor or computer system (“E”), shared by multiple agents (“S”), or is invalid (“I”) (“MESI” states). Furthermore, in other embodiments of the invention, cache lines may also contain state information to indicate some combination of the above MESI states, such as “Ml” to indicate that a line is modified with respect to accesses from other agents in the computer system and invalid with respect to a particular processor core or cores with which the cache is associated, “MS” to indicate that a line of cache is modified with respect to accesses from other agents in the computer system and shared with respect to a particular processor core or cores with which the cache is associated. Cache lines may also contain state information, “ES”, to indicate that a cache line is shared by a group of agents, such as processor cores within a processor, but exclusively owned with respect to other processors within a computer system.

By taking into consideration these or other lower level cache line states when choosing which cache line of an upper level cache to evict, embodiments of the invention can prevent excessive accesses by a processor or processor core to alternative slower memory sources, such as main memory. Accesses to alternative slower memory sources in a computer system can cause delays in the retrieval of data, thereby causing a requesting processor or core, as well as the computer system in which it is contained, to incur performance penalties.

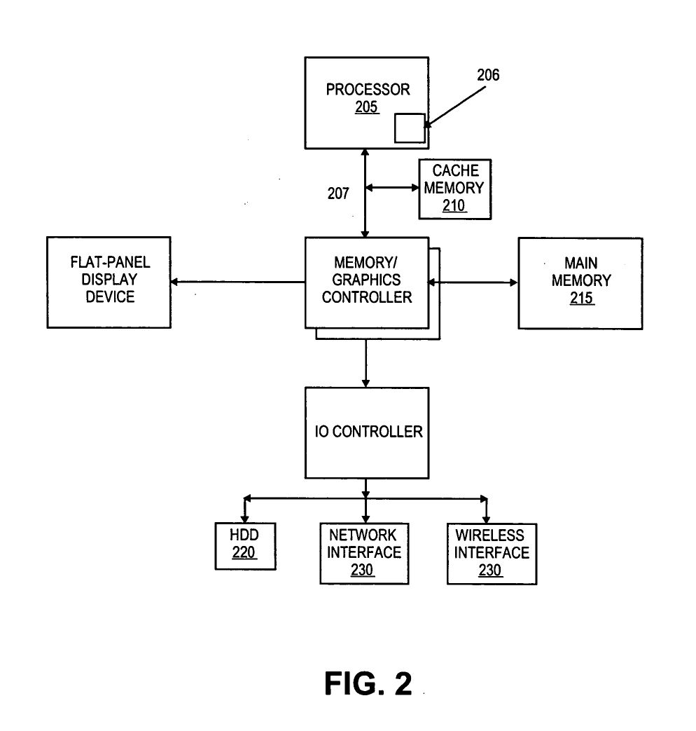

FIG. 2 illustrates a front-side-bus (FSB) computer system in which one embodiment of the invention may be used. A processor 205 accesses data from a level one (L1) cache memory 210 and main memory 215. In other embodiments of the invention, the cache memory may be a level two (L2) cache or other memory within a computer system memory hierarchy. Furthermore, in some embodiments, the computer system of FIG. 2 may contain both a L1 cache and an L2 cache, which comprise an inclusive cache hierarchy in which coherency data is shared between the L1 and L2 caches.

Illustrated within the processor of FIG. 2 is one embodiment of the invention 206. Other embodiments of the invention, however, may be implemented within other devices within the system, such as a separate bus agent, or distributed throughout the system in hardware, software, or some combination thereof.

The main memory may be implemented in various memory sources, such as dynamic random-access memory (DRAM), a hard disk drive (HDD) 220, or a memory source located remotely from the computer system via network interface 230 containing various storage devices and technologies. The cache memory may be located either within the processor or in close proximity to the processor, such as on the processor's local bus 207. Furthermore, the cache memory may contain relatively fast memory cells, such as a six-transistor (6T) cell, or other memory cell of approximately equal or faster access speed.

The computer system of FIG. 2 may be a point-to-point (PtP) network of bus agents, such as microprocessors, that communicate via bus signals dedicated to each agent on the PtP network. Within, or at least associated with, each bus agent is at least one embodiment of invention 206, such that store operations can be facilitated in an expeditious manner between the bus agents.

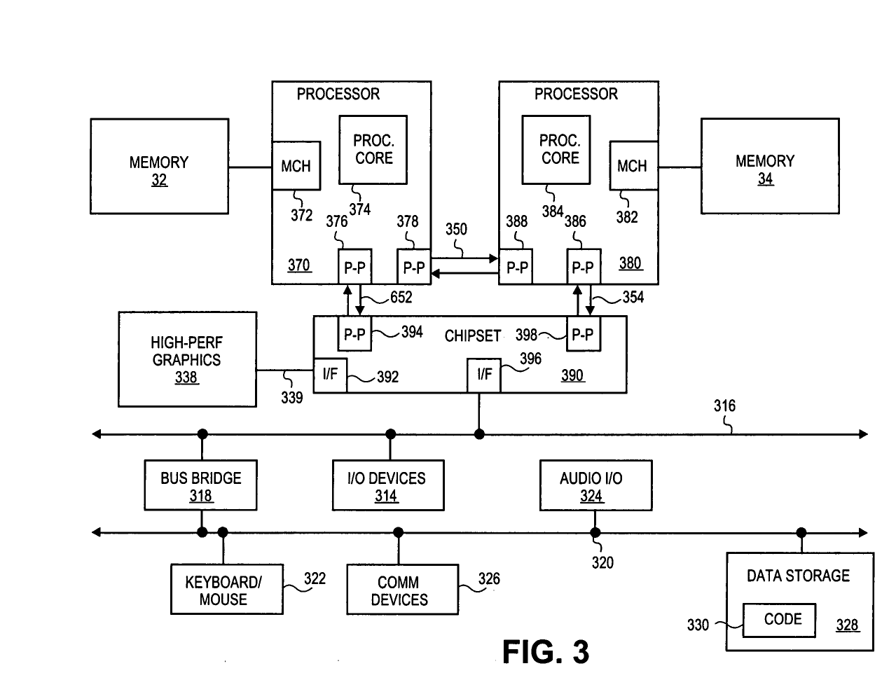

FIG. 3 illustrates a computer system that is arranged in a point-to-point (PtP) configuration. In particular, FIG. 3 shows a system where processors, memory, and input/output devices are interconnected by a number of point-to-point interfaces.

The system of FIG. 3 may also include several processors, of which only two, processors 370, 380 are shown for clarity. Processors 370, 380 may each include a local memory controller hub (MCH) 372, 382 to connect with memory 22, 24. Processors 370, 380 may exchange data via a point-to-point (PtP) interface 350 using PtP interface circuits 378, 388. Processors 370, 380 may each exchange data with a chipset 390 via individual PtP interfaces 352, 354 using point to point interface circuits 376, 394, 386, 398. Chipset 390 may also exchange data with a high-performance graphics circuit 338 via a high-performance graphics interface 339.

At least one embodiment of the invention may be located within the PtP interface circuits within each of the PtP bus agents of FIG. 3. Other embodiments of the invention, however, may exist in other circuits, logic units, or devices within the system of FIG. 3. Furthermore, other embodiments of the invention may be distributed throughout several circuits, logic units, or devices illustrated in FIG. 3.

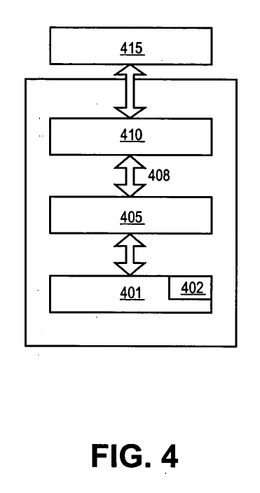

FIG. 4 illustrates a single core microprocessor in which one embodiment of the invention may be used. Specifically, FIG. 4 illustrates a processor core 401, which can access data directly from an L1 cache 405. The L1 cache can contain a subset of data within the typically larger L2 cache that is to be accessed less frequently than data in the typically smaller L1 cache. In order to maintain coherency between data stored in the L1 and L2 caches, coherency information 408 is typically exchanged between the L1 and L2 caches. By maintaining coherency between the L1 and L2 caches, an inclusive cache hierarchy, such as the one illustrated in FIG. 4 can improve cache access performance by allowing more frequently used data to be accessed from the L1 cache and less frequently data to be accessed from the L2 cache. Furthermore, the inclusive cache hierarchy of FIG. 4 can minimize the number of accesses that a processor core must make to alternative slower memories stored on the bus 415. One embodiment of the invention 402 may be located in the processor core. Alternatively, other embodiments may be located outside of the processor core, within the caches, or distributed throughout the processor of FIG. 4. Furthermore, embodiments of the invention may exist outside of the processor of FIG. 4.

The processor of FIG. 4 may be part of a larger computer system in which other processors can access the L1 and L2 caches of FIG. 4. Furthermore, other processors in the system typically access data from the L2 cache of FIG. 4 rather than the L1 cache, which is typically dedicated to a particular processor core. Therefore, each L2 cache line may contain state information that pertains to accesses from other processors in the system, whereas the L1 cache may contain state information that pertains to accesses from the processor core(s) to which it corresponds.

For example, each cache line of the L2 cache in FIG. 4 may have one of the state variables, I, M, S, and E to indicate the state of the cache line as it applies to the system in which it reside. Furthermore, each line of the L1 cache may also have one of the same group of state variables to indicate the state of an L1 cache line as it relates to the particular processor core to which the L1 cache corresponds.

The coherency information of FIG. 4 may include not only the data to be stored within the L1 and/or L2 caches, but also state information pertaining to cache lines within the L1 and/or L2 caches. For each state of a cache line in the L1 cache, for example, there can be an associated performance penalty, or “cost”, resulting from an eviction of a cache line in the L2 cache. This cost is due to the fact that in an inclusive cache hierarchy, such as the one illustrated in FIG. 4, a cache line evicted in one cache structure, is also evicted in the other in order to maintain cache coherency between the two structures. Depending on the state of a cache line in the L1 cache corresponding to an evicted cache line in the L2 cache, the cost of the eviction can vary.

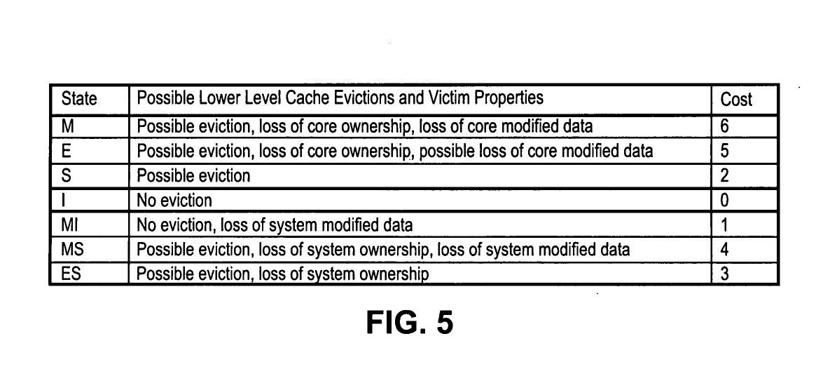

FIG. 5, for example, is a table illustrating the cost of evicting cache lines in the L2 cache due to the corresponding line in the L1 cache being evicted as a result. Particularly, FIG. 5 illustrates that for each upper level cache line state, M, E, S, I, and for each upper level cache line state in combination with each lower level cache line state, MI, MS, and ES, there is a potential cost based on the possible lower level cache eviction and victim properties.

For example, an L2 cache eviction of an M state line will potentially evict a line in the L1 cache, for which the core has ownership and which the core has previously modified. Evictions of L2 cache lines in the M state, therefore, may incur the highest cost penalty (indicated by a “6” in FIG. 5), because M state evictions may cause the core to resort to slower system memory, such as DRAM, to retrieve the data. On the other hand, L2 cache lines in the I state may be more of an attractive eviction option (indicated by cost “0” in FIG. 5), as their eviction does not cause a corresponding L1 cache eviction. FIG. 5 illustrates other costs associated with the eviction of other L2 cache lines based on the possible lower level cache evictions and victim properties.

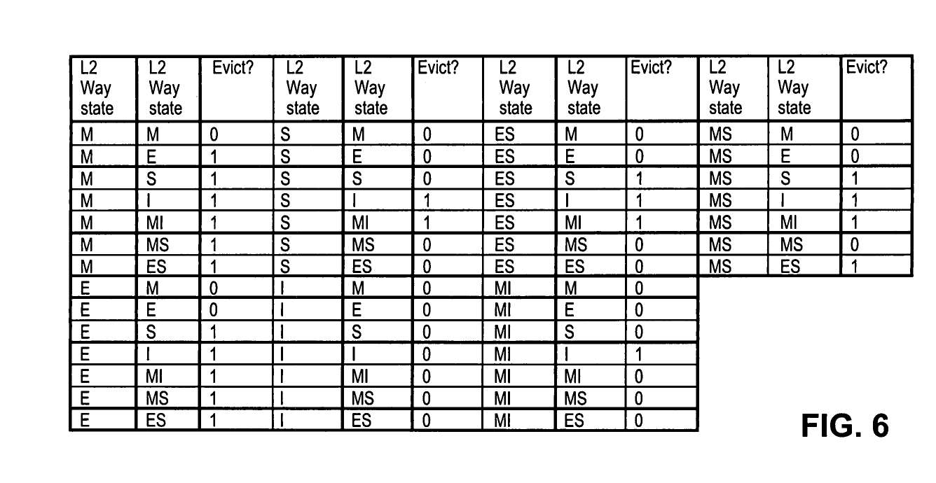

Based on the costs associated with each L2 cache line eviction, illustrated in FIG. 5, an algorithm and technique for choosing which L2 cache line should be evicted at any given time can be used that takes into account these costs and not simply, for example, the least-recently used (LRU) L2 cache line. FIG. 6, for example, is a table illustrating a cache line eviction policy, according to one embodiment of the invention, that can be used to choose which L2 cache line to evict based on the state of two entries in a cache line the L2 cache.

Particularly, FIG. 6 illustrates a truth table for every possible combination of cache line states between two ways of the four total ways of a set in an L2 set associative cache. In the embodiment illustrated in FIG. 6, the two ways represented in the table are chosen from the remainder of cache ways after another algorithm, such as an LRU algorithm, has been used to exclude the other ways of the cache line from consideration for replacement. For example, the table of FIG. 6 may correspond to a 4-way set associative cache, in one embodiment, in which two of the ways in the selected set have been deselected for replacement by another algorithm, such as an LRU algorithm. In other embodiments, the number of ways that may be considered in the table of FIG. 6 may be different. Furthermore, in other embodiments, the number of cache ways not selected for consideration in the table of FIG. 6 may be different.

For each pair of L2 cache way states in FIG. 6, a “1” or “0” indicates whether the cache line corresponding to that way should be evicted. For example, when choosing between an L2 cache way containing an M state and an L2 cache way containing an I state, the line in I state should be chosen, as indicated by a “1” in the “evict?” column of FIG. 6. This is because, as indicated in FIG. 4, an M state line in an L2 cache way can cause the loss of modified data in the corresponding L1 cache way, thereby incurring a high cost (indicated by “6”, in FIG. 5) to system performance. Also, an L2 cache way with an I state typically will not be evicted from the corresponding L1 cache entry, and therefore has a lower associated cost, as indicated in the “cost” column in FIG. 5.

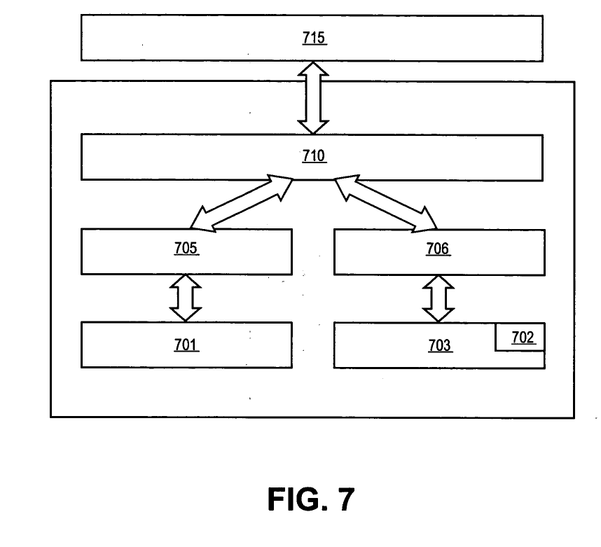

Although the examples illustrated in FIGS. 4-6 apply to inclusive cache hierarchies within single core microprocessors, other embodiments of the invention may apply to multi-core processors and their associated computer systems. For example, FIG. 7 illustrates a dual core processor in which one embodiment of the invention may be used.

Particularly, each core 701 703 of the processor of FIG. 7 has associated with it an L1 cache 705 706. However, both cores and their associated L1 caches correspond to the same L2 cache 710. However, in other embodiments, each L1 cache may correspond to a separate L2 cache. Coherency information 708 is exchanged between each L1 cache and the L2 cache in order to update data and state information between the two layers of caches, such that the cores can access more frequently used data from their respective L1 caches and less frequently used data from the L2 cache without having to resort to accessing this data from alternative slower memory sources residing on the bus 715.

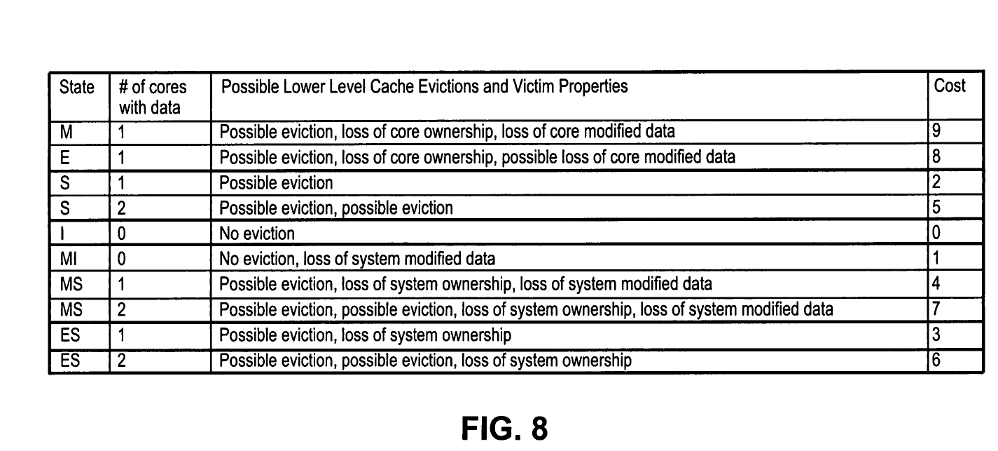

Similar to FIG. 5, FIG. 8 is a table illustrating the cost of evicting L2 cache entries based on the L2 cache state and the corresponding possible L1 cache evictions and victim properties. In addition to those states of FIG. 5, FIG. 8 also includes three extra states corresponding to shared cache lines that may exist between the two cores of FIG. 7. Accordingly, FIG. 8 includes cost information for extra shared cache line states, S, MS, and ES, corresponding to the extra core of FIG. 7. More cost information state information may be included in the table of FIG. 8 for processors containing more than two cores and two L1 caches.

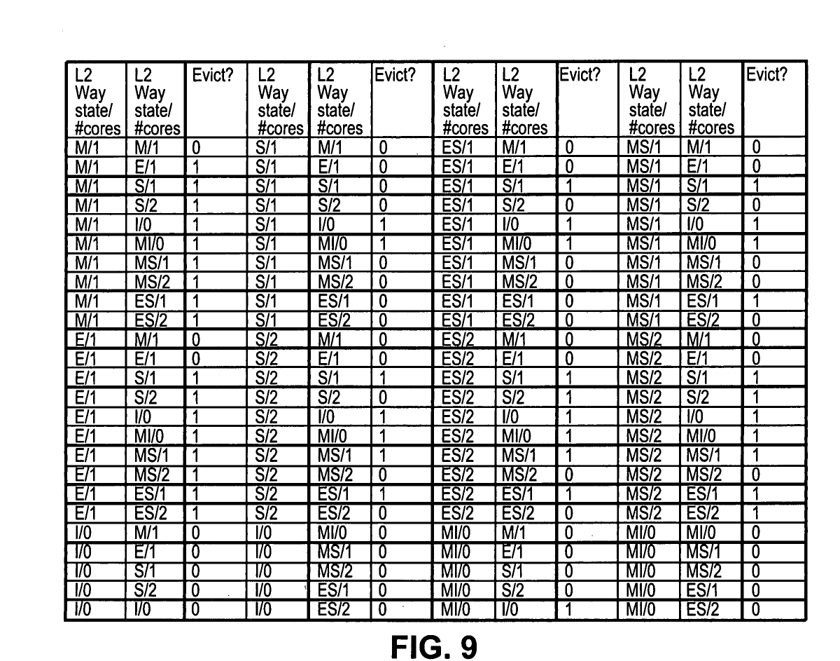

Similar to FIG. 6, FIG. 9 is a truth table corresponding to the dual core processor of FIG. 7 and the cost table of FIG. 8, illustrating an algorithm for determining which L2 cache line should be evicted given the state of two L2 cache ways and the corresponding cost of evicting the L1 cache line associated therewith. However, FIG. 9 illustrates not only the state values corresponding to a single core processor, as in FIG. 6, but also those state values corresponding to the dual core processor of FIG. 7. More entries may exist in the truth table of FIG. 9 as more cores, and corresponding L1 caches, are used in the processor of FIG. 7.

Throughout the examples illustrated herein, the inclusive cache hierarchy is composed of two levels of cache containing a single L1 cache and L2 cache, respectively. However, in other embodiments, the cache hierarchy may include more levels of cache and/or more L1 cache and/or L2 cache structures in each level.

Embodiments of the invention described herein may be implemented with circuits using complementary metal-oxide-semiconductor devices, or “hardware”, or using a set of instructions stored in a medium that when executed by a machine, such as a processor, perform operations associated with embodiments of the invention, or “software”. Alternatively, embodiments of the invention may be implemented using a combination of hardware and software.

While the invention has been described with reference to illustrative embodiments, this description is not intended to be construed in a limiting sense. Various modifications of the illustrative embodiments, as well as other embodiments, which are apparent to persons skilled in the art to which the invention pertains are deemed to lie within the spirit and scope of the invention.

1. An apparatus comprising:
an upper level cache having an upper level cache line;
a lower level cache having a lower level cache line;
an eviction unit to evict the upper level cache line depending on state information corresponding to the lower level cache line.

2. The apparatus of claim 1 wherein the state information is chosen from a group consisting of: modified, exclusive, shared, invalid.

3. The apparatus of claim 2 wherein the upper level cache comprises a level-2 (L2) cache.

4. The apparatus of claim 3 wherein the lower level cache comprises a level-1 (L1) cache.

5. The apparatus of claim 4 further comprising a processor core to access data from the L1 cache.

6. The apparatus of claim 3 wherein the lower level cache comprises a plurality of level-1 (L1) cache memories.

7. The apparatus of claim 6 further comprising a plurality of processor cores corresponding to the plurality of L1 cache memories.

8. A system comprising:
a plurality of bus agents, at least one of the plurality of bus agents comprising an inclusive cache hierarchy including an upper level cache and a lower level cache, in which cache line evictions from the upper level cache are to be based, at least in part, on whether there will be a resulting lower level cache eviction.

9. The system of claim 8 wherein whether there will be a resulting lower level cache eviction depends, at least in part, on a state value of a line to be evicted from the upper level cache chosen from a plurality of state values consisting of: modified invalidate, modified shared, and exclusive shared.

10. The system of claim 9 wherein the plurality of bus agents can access the upper level cache of the at least one of the plurality of bus agents.

11. The system of claim 10 wherein the at least one of the plurality of bus agents comprises a processor core to access the lower level cache.

12. The system of claim 11 wherein the lower level cache comprises at least one level-1 cache.

13. The system of claim 12 wherein the upper level cache comprises a level-2 cache.

14. The system of claim 13 wherein the upper level cache and the lower level cache are to exchange coherency information to maintain coherency between the upper level and lower level cache.

15. A method comprising:
determining whether to evict an upper level cache line within an inclusive cache memory hierarchy based, at least in part, on the effect of a corresponding lower level cache line;
evicting the upper level cache line.

16. The method of claim 15 further comprising replacing the upper level cache line with more recently used data.

17. The method of claim 16 wherein the determining depends upon the cost to system performance of evicting the upper level cache line.

18. The method of claim 17 wherein evicting invalid upper level cache lines has no system performance cost.

19. The method of claim 18 wherein evicting a modified upper level cache line has the most system performance cost of any other cache line eviction.

20. The method of claim 19 wherein the determination further depends upon whether the eviction of the upper level cache line will cause corresponding lower level cache line to be evicted.

21. The method of claim 20 whether an eviction from the upper level cache line will occur depends upon a state variable chosen from a group consisting of: modified, exclusive, shared, and invalid.

22. The method of claim 21 wherein the upper level cache line is a level-2 cache line and the lower level cache line is a level-1 cache line.

23. An apparatus comprising:
an upper level cache having an upper level cache line;
a lower level cache having a lower level cache line;
an eviction means for evicting the upper level cache line depending on a state of lower level cache way.

24. The apparatus of claim 23 wherein the eviction means includes a state of
the upper level cache way chosen from a group consisting of:
modified, exclusive, shared, and invalid.

25. The apparatus of claim 24 wherein the upper level cache comprises a level-2 (L2) cache.

26. The apparatus of claim 25 wherein the lower level cache comprises a level-1 (L1) cache.

27. The apparatus of claim 26 wherein the eviction means further comprises a processor core to access data from the L1 cache.

28. The apparatus of claim 25 wherein the lower level cache comprises a plurality of level-1 (L1) cache memories.

29. The apparatus of claim 28 wherein the eviction means further comprises a plurality of processor cores corresponding to the plurality of L1 cache memories.

30. The apparatus of claim 23 wherein the eviction means comprises at least one instruction, which if executed by a machine causes the machine to perform a method comprising:
determining whether to evict the upper level cache line based, at least in part, on the effect of the lower level cache line;
evicting the upper level cache line.
